(19) United States
(12) Patent Application Publication
(10) Pub. No.: US 2021/0331883 A1
(43) Pub. Date: Oct. 28, 2021

(54) MEDIUM CONVEYOR APPARATUS

(71) Applicant: PFU Limited, Ishikawa (JP)

(72) Inventor: Ryo Hayashi, Ishikawa (JP)

(21) Appl. No.: 17/369,582

(22) Filed: Jul. 7, 2021

Related U.S. Application Data
(63) Continuation of application No. PCT/JP2019/011279, filed on Mar. 18, 2019.

(51) Int. Cl. B65H 3/06; B65H 5/06

(52) U.S. Cl. CPC B65H 3/0669; B65H 5/062

(57) ABSTRACT

A medium conveyor apparatus includes a main body, a first roller that is rotatably supported by the main body, and that receives a rotating force from a driving source, a bearing that is translationally movably supported by the main body, a second roller that is rotatably supported by the bearing, and that presses a medium against the first roller, and a rotation communicator that communicates a rotation from the driving source to the second roller, without communicating a rotation from the second roller to the driving source.

### CROSS-REFERENCE TO RELATED APPLICATION

This application is a continuation of International Application No. PCT/JP2019/011279, filed on Mar. 18, 2019, the entire contents of which are incorporated herein by reference.

### FIELD

The embodiment discussed herein is related to a medium conveyor apparatus.

### BACKGROUND

A medium conveyor apparatus has been known that conveys a medium by rotating one roller in a roller pair, while the medium is pressed against the one roller by the other roller. Japanese Laid-open Patent Publication No. H04-39237 discloses a sheet conveyor apparatus that uses a torque limiter to keep the amount of a recording medium that is conveyed constantly. Japanese Laid-open Patent Publication No. S61-254443 discloses a paper conveyor apparatus that uses one-way clutches to convey paper at two slightly different paper conveying speeds. Japanese Unexamined Utility Model Registration Application No. S62-140043 discloses a paper conveyor apparatus that uses one-way clutches to enable a driving source that rotates forwardly and reversely to keep conveying paper in one direction.

However, when the other roller is configured to be rotated by following the movement of the one roller, sometimes the medium conveyor apparatus becomes incapable of achieving a sufficient grabbing force for allowing the medium to move to enter between the rollers, and experiences a failure in which the medium is not conveyed to enter between the rollers appropriately. Furthermore, in a configuration of the medium conveyor apparatus in which rollers in a roller pair are driven in rotation but at different peripheral velocities, the load imposed on the driving source for driving the roller pair in rotation sometimes increases.

### SUMMARY

According to an aspect of an embodiment, a medium conveyor apparatus includes a main body, a first roller that is rotatably supported by the main body, and that receives a rotating force from a driving source, a bearing that is translationally movably supported by the main body, a second roller that is rotatably supported by the bearing, and that presses a medium against the first roller, and a rotation communicator that communicates a rotation from the driving source to the second roller, without communicating a rotation from the second roller to the driving source.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a sectional side view illustrating an image reader apparatus provided with a medium conveyor apparatus according to a first embodiment;

FIG. 2 is a perspective view illustrating a conveyor unit;

FIG. 3 is a front view illustrating the conveyor unit;

FIG. 4 is a front view illustrating the conveyor unit with a thick medium nipped between first feed rollers and first pressure rollers;

FIG. 5 is a side view illustrating the first feed rollers and the first pressure rollers when a thin medium is sent out into the medium reading conveying path;

FIG. 6 is a side view illustrating the first feed rollers and the first pressure rollers when a thick medium is sent out into the medium reading conveying path;

FIG. 7 is a side view illustrating first feed rollers and first pressure rollers included in a medium conveyor apparatus according to a comparative example 1;

FIG. 8 is a schematic front view illustrating a driving force communicating path along which the rotating force is communicated from the driving source to the first pressure rollers; and

FIG. 9 is a schematic side view illustrating the first feed rollers and the first pressure rollers when the first pressure rollers have a radius smaller than that of the first feed roller.

### DESCRIPTION OF EMBODIMENTS

Preferred embodiments of the disclosure will be explained with reference to accompanying drawings. A medium conveyor apparatus according to an embodiment of the present disclosure will be explained with reference to some drawings. The following description is, however, not intended to limit the scope of the technology according to the present disclosure in any way. Furthermore, in the following description, the same elements are given the same reference numerals, and redundant explanations thereof will be omitted.

### First Embodiment

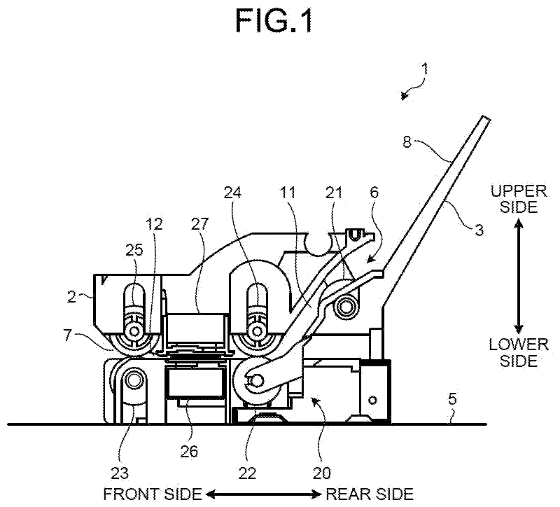

FIG. 1 is a sectional side view illustrating an image reader apparatus 1 provided with a medium conveyor apparatus according to a first embodiment. The image reader apparatus 1 includes, as illustrated in FIG. 1, an image reader apparatus main body 2 and a feed tray 3. The image reader apparatus main body 2 has a box-like shape, and is placed on an installation surface 5 where the image reader apparatus 1 is installed. The image reader apparatus main body 2 has a paper feeding opening 6 and a discharge opening 7. The paper feeding opening 6 is provided on the rear side of the image reader apparatus 1. The discharge opening 7 is provided on the front side that is on the opposite side of the rear side where the paper feeding opening 6 is provided in the image reader apparatus 1.

The feed tray 3 has a placing surface 8. The feed tray 3 has the placing surface 8 extending diagonally upwards, and is provided on the rear side of the image reader apparatus main body 2 in such a manner that the placing surface 8 follows another plane inclined with respect to a plane stretching across the installation surface 5. The feed tray 3 is positioned near the paper feeding opening 6 so that the medium placed on the placing surface 8 moves toward the paper feeding opening 6 due to the gravity, and is fixed to the image reader apparatus main body 2.

The image reader apparatus main body 2 also has a conveying path. The conveying path is provided inside of the image reader apparatus main body 2, and connects the paper feeding opening 6 and the discharge opening 7. The conveying path includes a medium separating conveying path 11 and a medium reading conveying path 12. One end of the medium separating conveying path 11 is connected to the paper feeding opening 6, and the other end of the medium separating conveying path 11 is connected to the medium reading conveying path 12. The medium reading conveying path 12 is provided in a manner extending along another plane that is in parallel with the plane stretching across the installation surface 5. One end of the medium reading conveying path 12 is connected to the medium separating conveying path 11, and the other end of the medium reading conveying path 12 is connected to the discharge opening 7.

The image reader apparatus 1 also includes a conveyor unit 20. The conveyor unit 20 includes a separating unit 21, first feed rollers 22, second feed rollers 23, first pressure rollers 24, and second pressure rollers 25. The separating unit 21 is provided in the middle of the medium separating conveying path 11. The separating unit 21 separates one medium from a plurality of media inserted from the paper feeding opening 6 into the medium separating conveying path 11, and conveys the separated one of the media toward the medium reading conveying path 12, along the medium separating conveying path 11.

The first feed rollers 22 have a cylindrical shape. The first feed rollers 22 are positioned below the medium reading conveying path 12 so as to be brought into contact with the medium located in the medium reading conveying path 12. The first feed rollers 22 are rotatably supported by the image reader apparatus main body 2. The first feed rollers 22 convey the medium located in the medium reading conveying path 12 toward the discharge opening 7, along the medium reading conveying path 12, by being rotated forwardly (counterclockwise in FIG. 1). The second feed rollers 23 have such a cylindrical shape that the radius of a cylinder formed by the second feed roller 23 is generally equal to that of a cylinder formed by the first feed roller 22. The second feed rollers 23 are positioned between the first feed rollers 22 and the discharge opening 7 below the medium reading conveying path 12, so as to be brought into contact with the medium located in the medium reading conveying path 12. The second feed rollers 23 are rotatably supported by the image reader apparatus main body 2. The second feed rollers 23 convey the medium located in the medium reading conveying path 12, toward the discharge opening 7 along the medium reading conveying path 12, by being rotated forwardly (counterclockwise in FIG. 1).

The first pressure rollers 24 have such a cylindrical shape that the radius of a cylinder formed by the first pressure roller 24 is generally equal to that of the cylinder formed by the first feed roller 22. The first pressure rollers 24 are positioned above the medium reading conveying path 12 and on top of the first feed rollers 22, so as to be brought into contact with the medium located in the medium reading conveying path 12. The first pressure rollers 24 are supported by the image reader apparatus main body 2 rotationally, and translationally movably in the up-and-down direction that is perpendicular to the plane stretching across the installation surface 5. The first pressure rollers 24 press the medium located in the medium reading conveying path 12 against the first feed rollers 22. The first pressure rollers 24 convey the medium located in the medium reading conveying path 12 toward the discharge opening 7 along the medium reading conveying path 12, by being rotated forwardly (clockwise in FIG. 1)

The second pressure rollers 25 have such a cylindrical shape that the radius of a cylinder formed by the second pressure roller 25 generally equal to that of the cylinder formed by the second feed roller 23. The second pressure rollers 25 are positioned above the medium reading conveying path 12 and on top of the second feed rollers 23, so as to be brought into contact with the medium located in the medium reading conveying path 12. The second pressure rollers 25 are supported by the image reader apparatus main foody 2 rotatably, and translationally movably in the up-and-down direction. The second pressure rollers 25 press the medium located in the medium reading conveying path 12 against the second feed rollers 23. The second pressure rollers 25 convey the medium located in the medium reading conveying path 12 toward the discharge opening 7 along the medium reading conveying path 12, by being rotated forwardly (clockwise in FIG. 1).

The image reader apparatus 1 also includes a lower reading unit 26 and an upper reading unit 27. The lower reading unit 26 is implemented as a contact image sensor (CIS). The lower reading unit 26 is positioned below the medium reading conveying path 12, and is positioned between the first feed rollers 22 and the second feed rollers 23. The lower reading unit 26 reads the image on the bottom surface of the medium that is conveyed along the medium reading conveying path 12. The lower reading unit 26 is implemented as a CIS. The upper reading unit 27 is positioned above the medium reading conveying path 12, on top of the lower reading unit 26, and between the first pressure rollers 24 and the second pressure rollers 25. The upper reading unit 27 reads the image on the top surface of the medium that is conveyed along the medium reading conveying path 12.

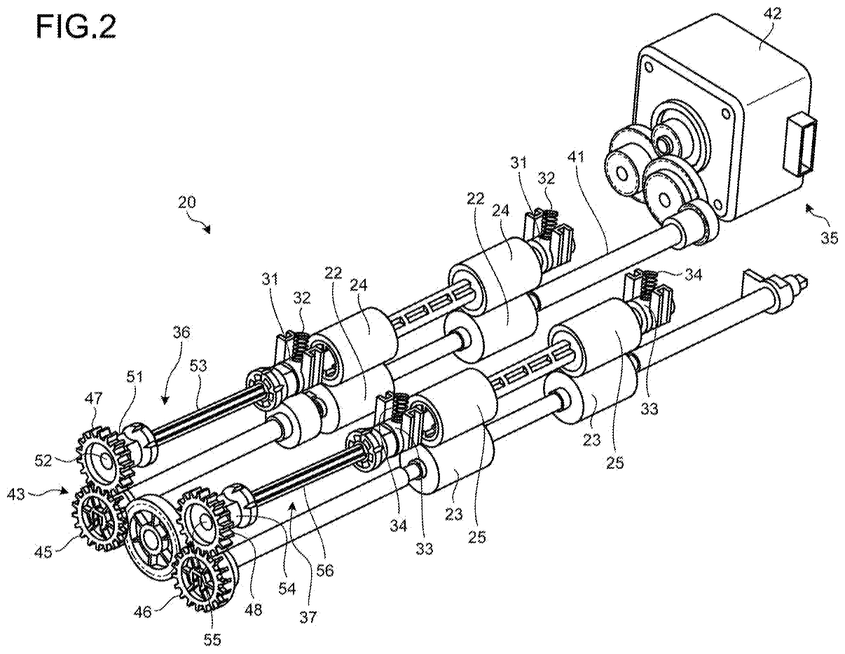

FIG. 2 is a perspective view illustrating the conveyor unit 20. The conveyor unit 20 also includes, as illustrated in FIG. 2, first bearings 31, first pressurizing springs 32, second bearings 33, and second pressurizing springs 34. The first bearings 31 are supported by the image reader apparatus main body 2 translationally movably in the up-and-down direction. The first pressure rollers 24 are rotatably supported by the first bearings 31. In other words, the first pressure rollers 24 are supported by the image reader apparatus main body 2 via the first bearings 31 rotatably, and translationally movably in the up-and-down direction. The first pressurizing springs 32 are provided as compressed coil springs, and apply a pressing force to the respective first bearings 31, so that the first pressure rollers 24 are moved closer to the first feed rollers 22.

The second bearings 33 are supported by the image reader apparatus main body 2 translationally movably in the up-and-down direction. The second pressure rollers 25 are rotatably supported by the second bearings 33. Therefore, the second pressure rollers 25 are supported by the image reader apparatus main body 2 rotatably, and translationally movably in the up-and-down direction. The second pressurizing springs 34 are provided as compressed coil springs, and apply a pressing force to the second bearings 33, so that the second pressure rollers 25 are moved closer to the second feed rollers 23.

The conveyor unit 20 also includes a driving source 35, a first rotation communicating mechanism 36, and a second rotation communicating mechanism 37. The driving source 35 includes a driving shaft 41, a conveying motor 42, and a plurality of gears 43. The driving shaft 41 has a rod-like shape, and is supported by the image reader apparatus main body 2 rotatably about a rotational axis matching the rotational axis of the first feed rollers 22. The conveying motor 42 is supported by the image reader apparatus main body 2, and rotates the driving shaft 41 forwardly.

The gears 43 are rotatably supported by the image reader apparatus main body 2, and are meshed with one another. The gears 43 include a first feed gear 45, a second feed gear 46, a first pressure roller gear 47, and a second pressure roller gear 48. The first feed gear 45 is fixed to the driving shaft 41, and is fixed to the first feed rollers 22 via the driving shaft 41. The second feed gear 46 is fixed to the second feed rollers 23. The gears 43 are configured in such a manner that, when the driving shaft 41 is rotated forwardly, the first feed gear 45, the second feed gear 46, the first pressure roller gear 47, and the second pressure roller gear 48 are rotated forwardly. The gears 43 are also configured so that the rotational frequency of the first feed gear 45, the rotational frequency of the second feed gear 46, the rotational frequency of the first pressure roller gear 47, and the rotational frequency of the second pressure roller gear 48 are equal to the rotational frequency of the driving shaft 41.

The first rotation communicating mechanism 36 includes a first pressure roller driving shaft 51, a first one-way clutch 52, and a first joint unit 53. The first pressure roller driving shaft 51 is supported by the image reader apparatus main body 2 rotatably about a rotational axis matching the rotational axis of the first pressure roller gear 47.

The first one-way clutch 52 is provided between the first pressure roller gear 47 and the first pressure roller driving shaft 51. The first one-way clutch 52 communicates the rotation of the first pressure roller gear 47 to the first pressure roller driving shaft 51 so that, when the first pressure roller gear 47 is rotated forwardly, the first pressure roller driving shaft 51 is rotated forwardly. The first one-way clutch 52 is also configured not to communicate the rotation of the first pressure roller driving shaft 51 to the first pressure roller gear 47 so that, when the rotational frequency at which the first pressure roller driving shaft 51 is rotated forwardly is higher than the rotational frequency at which the first pressure roller gear 47 is rotated forwardly.

The first joint unit 53 is implemented as a universal joint, and is provided between the first pressure roller driving shaft 51 and the first pressure rollers 24. The first joint unit 53 communicates the rotation of the first pressure roller driving shaft 51 to the first pressure rollers 24 even when the rotational axis of the first pressure rollers 24 is not aligned with the rotational axis of the first pressure roller driving shaft 51.

The second rotation communicating mechanism 37 includes a second pressure roller driving shaft 54, a second one-way clutch 55, and a second joint, unit 56. The second pressure roller driving shaft 54 is supported by the image reader apparatus main body 2 rotatably about a rotational axis matching the rotational axis of the second pressure roller gear 48.

The second one-way clutch 55 is provided between the second pressure roller gear 48 and the second pressure roller driving shaft 54. The second one-way clutch 55 communicates the rotation of the second pressure roller gear 48 to the second pressure roller driving shaft 54 so that, when the second pressure roller gear 48 is rotated forwardly, the second pressure roller driving shaft 54 is rotated forwardly. The second one-way clutch 55 is also configured not to communicate the rotation of the second pressure roller driving shaft 54 to the second pressure roller gear 48 when the rotational frequency at which the second pressure roller driving shaft 54 is rotated forwardly is higher than the rotational frequency at which the second pressure roller gear 48 is rotated forwardly.

The second joint unit 56 is implemented as a universal joint, and is provided between the second pressure roller driving shaft 54 and the second pressure rollers 25. The second joint unit 56 communicates the rotation of the second pressure roller driving shaft 54 to the second pressure rollers 25 even when the rotational axis of the second pressure rollers 25 is not aligned with rotational axis of the second pressure roller driving shaft 54.

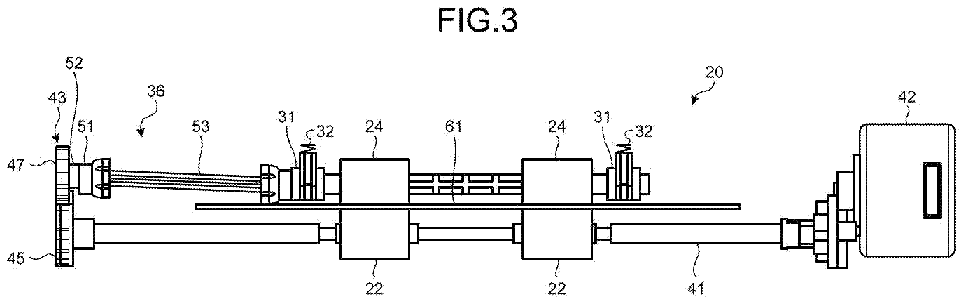

FIG. 3 is a front view illustrating the conveyor unit 20. When the first feed rollers 22 are in contact with the first pressure rollers 24, the rotational axis of the first pressure rollers 24 is positioned below the rotational axis of the first pressure roller driving shaft 51. When a thin medium 61 is nipped between the first feed rollers 22 and the first pressure rollers 24, the rotational axis of the first pressure rollers 24 is sometimes positioned below the rotational axis of the first pressure roller driving shaft 51. An example of the thin medium 61 includes a sheet of copy paper. Even when the rotational axis of the first, pressure rollers 24 is positioned below the rotational axis of the first pressure roller driving shaft 51, the rotation of the first pressure roller driving shaft 51 is communicated to the first pressure rollers 24 via the first joint unit 53. Therefore, even in a condition in which the rotational axis of the first pressure rollers 24 is positioned above the rotational axis of the first pressure roller driving shaft 51, when the first pressure roller driving shaft 51 is rotated forwardly, the first pressure rollers 24 can be appropriately rotated forwardly.

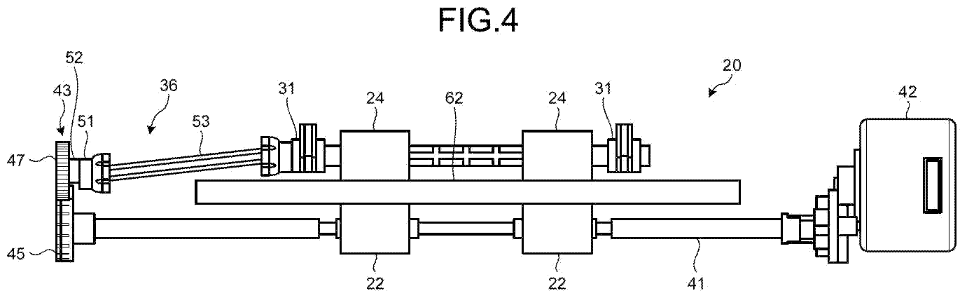

FIG. 4 is a front view illustrating the conveyor unit 20 when a thick medium 62 is nipped between the first feed rollers 22 and the first pressure rollers 24. When the thick medium 62 is nipped between the first feed rollers 22 and the first pressure rollers 24, the rotational axis of the first pressure rollers 24 is sometimes positioned above the rotational axis of the first pressure roller driving shaft 51. The thick medium 62 is thicker than the thin medium 61, and its examples include a card made of plastic and a brochure that is a plurality of paper media bounded together. Even when the rotational axis of the first pressure rollers 24 is positioned above the rotational axis of the first pressure roller driving shaft 51, the rotation of the first pressure roller driving shaft 51 is communicated to the first pressure rollers 24 via the first joint unit 53. Therefore, even in a condition in which the rotational axis of the first pressure rollers 24 is positioned above the rotational axis of the first pressure roller driving shaft 51, when the first pressure roller driving shaft 51 is rotated forwardly, the first pressure rollers 24 can be appropriately rotated forwardly.

### Operation of Image Reader Apparatus 1

When a user wants to read the image on one medium using the image reader apparatus 1, the user places the one medium on the feed tray 3, and when the user wants to read the images on a plurality of respective media using the image reader apparatus 1, the user places the media on the feed tray 3. Because the feed tray 3 is inclined, the medium placed on the feed tray 3 moves toward the paper feeding opening 6 along the placing surface 8 due to its own weight, and is brought into contact with the separating unit 21. When one medium is in contact with the separating unit 21, the separating unit 21 conveys the one medium toward the medium reading conveying path 12, along the medium separating conveying path 11. When a plurality of media are in contact with the separating unit 21, the separating unit 21 separates one medium from the media, and conveys the separated one medium toward the medium reading conveying path 12 along the medium separating conveying path 11. The one medium conveyed toward the medium reading conveying path 12 along the medium separating conveying path 11 is sent out into the medium reading conveying path 12.

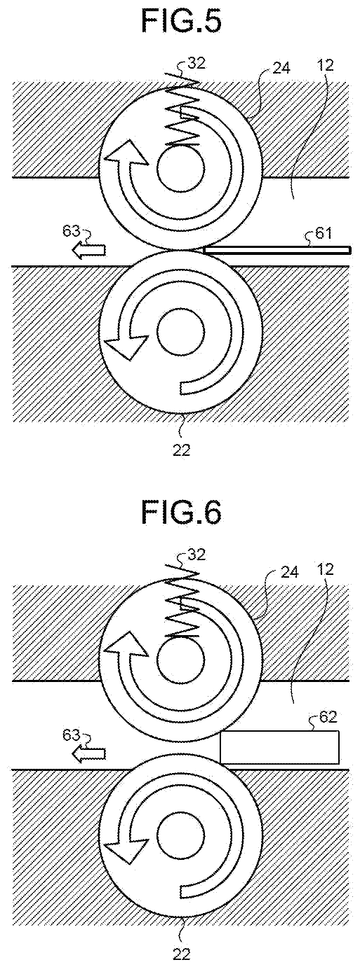

When the thin medium 61 is sent out into the medium reading conveying path 12, the first feed rollers 22 and the first pressure rollers 24 are brought into contact with the thin medium 61, as illustrated in FIG. 5. FIG. 5 is a side view illustrating the first feed rollers 22 and the first pressure rollers 24 when the thin medium 61 is sent out into the medium reading conveying path 12. The first feed rollers 22 guide the thin medium 61 in a conveying direction 63 that leads to the discharge opening 7 by being rotated forwardly while being kept in contact with the thin medium 61, and generate the grabbing force for allowing the thin medium 61 to move to enter between the first feed rollers 22 and the first pressure rollers 24. The first pressure rollers 24 guide the thin medium 61 in the conveying direction 63, and increase the grabbing force, by being rotated forwardly while being kept in contact with the thin medium 61. The thin medium 61 is moved to enter between the first feed rollers 22 and the first pressure rollers 24 when the grabbing force is sufficiently great.

After the thin medium 61 moves to enter between the first feed rollers 22 and the first pressure rollers 24, the first pressure rollers 24 press the thin medium 61 against the first feed rollers 22. The first feed rollers 22 convey the thin medium 61 in the conveying direction 63, along the medium reading conveying path 12, by being rotated forwardly while the first pressure rollers 24 are pressing the thin medium 61 against the first feed rollers 22.

When the thick medium 62 is sent out into the medium reading conveying path 12, the first feed rollers 22 and the first pressure rollers 24 are brought into contact with the thick medium 62, as illustrated in FIG. 6. FIG. 6 is a side view illustrating the first feed rollers 22 and the first pressure rollers 24 when the thick medium 62 is sent out into the medium reading conveying path 12. The first feed rollers 22 guide the thick medium 62 in the conveying direction 63 that leads to the discharge opening 7, and generate a grabbing force for allowing the thick medium 62 to move to enter between the first feed rollers 22 and the first pressure rollers 24, by being rotated forwardly while being kept in contact with the thick medium 62. The first pressure rollers 24 guides the thick medium 62 in the conveying direction 63, and increase the grabbing force, by being rotated forwardly while being kept in contact with the thick medium 62. When the grabbing force is sufficiently great, the thick medium 62 lifts up the first pressure rollers 24 against the pressing force of the first pressurizing springs 32, and moves to enter between the first feed rollers 22 and the first pressure rollers 24.

After the thick medium 62 moves to enter between the first feed rollers 22 and the first pressure rollers 24, the first pressure rollers 24 press the thick medium 62 against the first feed rollers 22. The first feed rollers 22 then convey the thick medium 62 along the medium reading conveying path 12 in the conveying direction 63 by being rotated forwardly while the first pressure rollers 24 are pressing the thick medium 62 against the first feed rollers 22. The medium, being conveyed by the first feed rollers 22 and the first pressure rollers 24 along the medium reading conveying path 12 in the conveying direction 63, is then conveyed between the lower reading unit 26 and the upper reading unit 27 in the medium reading conveying path 12. The lower reading unit 26 captures an image of the bottom surface of a part of the medium that is conveyed along the medium reading conveying path 12, the part being between a part that is in contact with the first feed rollers 22 and a part that is in contact with the second feed rollers 23. The upper reading unit 27 captures an image of the bottom surface of a part of the medium that is conveyed along the medium reading conveying path 12, the part being between a part that is in contact with the first pressure rollers 24 and a part that is in contact with the second pressure rollers 25.

The medium having its images captured is then brought into contact with the second feed rollers 23 and the second pressure rollers 25. The second feed rollers 23 and the second pressure rollers 25 allow the medium having its images captured, to enter between the second feed rollers 23 and the second pressure rollers 25, in the same manner as the first feed rollers 22 and the first pressure rollers 24. After the medium moves to enter between the second feed rollers 23 and the second pressure rollers 25, the second pressure rollers 25 press the medium against the second feed rollers 23. The second feed rollers 23 convey the medium along the medium reading conveying path 12 in the conveying direction 63, by being rotated forwardly while the second pressure rollers 25 are pressing the medium against the second feed rollers 23. The medium becomes separated from the first feed rollers 22 and the first pressure rollers 24 by being conveyed in the conveying direction 63. The medium becomes separated from the second feed rollers 23 and the second pressure rollers 25 by being further conveyed in the conveying direction 63, and is discharged from the discharge opening 7.

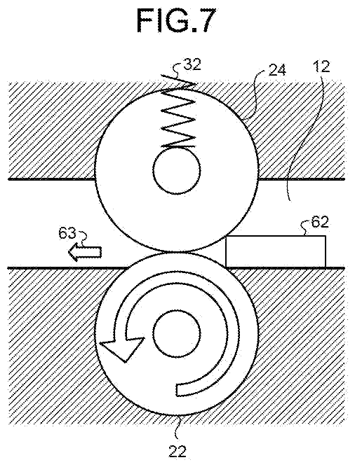

In a medium conveyor apparatus according to the comparative example 1, the first rotation communicating mechanism 36 is omitted from the image reader apparatus 1 provided with the medium conveyor apparatus according to the embodiment described above, and the other parts are the same as those in the image reader apparatus 1. FIG. 7 is a side view illustrating the first feed rollers 22 and the first pressure rollers 24 included in the medium conveyor apparatus according to the comparative example 1. The first feed rollers 22 guide the thick medium 62 in the conveying direction 63 that leads to the discharge opening 7, and generate a grabbing force for allowing the thick medium 62 to move to enter between the first feed rollers 22 and the first pressure rollers 24, by being rotated forwardly while being kept in contact with the thick medium 62. The first pressure rollers 24 do not have the rotation of the first pressure roller gear 47 communicated thereto, while being in contact with the thick medium 62, so as not to increase the grabbing force. Therefore, sometimes the grabbing force becomes smaller than a predetermined force. When the grabbing force is smaller than the predetermined force, the thick medium 62 cannot lift up the first pressure rollers 24 against the pressing force of the first pressurizing springs 32, and sometimes fails to move to enter between the first feed rollers 22 and the first pressure rollers 24. Because the thick medium 62 fails to move to enter between the first feed rollers 22 and the first pressure rollers 24, the medium conveyor apparatus according to the comparative example 1 sometimes fails to convey the thick medium 62 along the medium reading conveying path 12 in the conveying direction 63.

The medium conveyor apparatus according to the embodiment described above, when the first pressure rollers 24 are also rotated forwardly, can increase the grabbing force and allow the thick medium 62 to move to enter between the first feed rollers 22 and the first pressure rollers 24 appropriately. Therefore, compared with medium conveyor apparatus according to the comparative example, the medium conveyor apparatus according to the embodiment can convey the thick medium 62 appropriately along the medium reading conveying path 12 in the conveying direction 63.

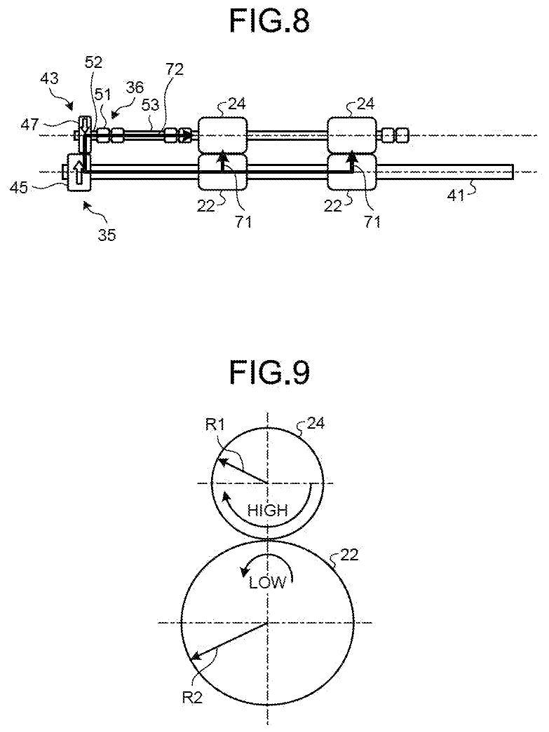

FIG. 8 is a schematic front view illustrating a driving force communicating path along which the rotating force is communicated from the driving source 35 to the first pressure rollers 24. The driving force communicating path includes a first driving force communicating path 71 and a second driving force communicating path 72. In the first driving force communicating path 71, the driving source 35 rotates the first feed rollers 22 forwardly, by rotating the driving shaft 41 forwardly. When the medium is not positioned in the medium reading conveying path 12, the first pressure rollers 24 are in contact with the first feed rollers 22. The first pressure rollers 24, while being in contact with the first feed rollers 22, are rotated forwardly by following the movement of the rotation of the first feed rollers 22.

In the second driving force communicating path 72, the driving source 35 rotates the first feed gear 45 forwardly by rotating the driving shaft 41 forwardly. As a result of the first feed gear 45 being rotated forwardly, the gears 43 rotates the first pressure roller gear 47 forwardly. The rotation of the first pressure roller gear 47 is communicated to the first pressure rollers 24 via the first rotation communicating mechanism 36, and the first pressure rollers 24 are rotated forwardly.

In the first pressure rollers 24, the radius R1 of the cylinder formed by the first pressure rollers 24 may change differently from the radius R2 of the cylinder formed by the first feed roller 22, as illustrated in FIG. 9. FIG. 9 is a schematic side view illustrating the first feed rollers 22 and the first pressure rollers 24 when the first pressure rollers 24 have a radius R1 smaller than the radius R2 of the first feed rollers 22. Such a change may occur as a result of the use of the image reader apparatus 1, because the first feed rollers 22 become worn out, or foreign substance become attached to the first pressure rollers 24, for example. An example of the foreign substance includes ink attached to the medium brought into contact with the first pressure rollers 24.

The peripheral velocity of the first pressure rollers 24 are equal to the peripheral velocity of the first feed rollers 22 when the first pressure rollers 24 are rotated by the rotating force communicated thereto via the first driving force communicating path 71, that is, when the first pressure rollers 24 follows the movement of the first feed rollers 22. The peripheral velocity of the roller indicates a value obtained by multiplying the rotational frequency of the roller and the radius of the cylinder formed by the roller. The rotational frequency of the rollers indicates the number of revolutions by which the rollers are rotated forwardly per unit time. When the radius R1 is smaller than the radius R2, with the first pressure rollers 24 following the movement the first feed rollers 22, the rotational frequency of the first pressure rollers 24 is higher than the rotational frequency of the first feed rollers 22. In other words, the rotational frequency of the first pressure rollers 24 is higher than the rotational frequency of the driving shaft 41, and is higher than the rotational frequency of the first pressure roller gear 47.

At this time, because the rotational frequency of the first pressure rollers 24 is higher than the rotational frequency of the first pressure roller gear 47, the first one-way clutch 52 does not communicate the rotation of the first pressure rollers 24 to the first pressure roller gear 47. In other words, the rotation of the driving shaft 41 is communicated to the first pressure roller gear 47 via the gears 43, and the first pressure roller gear 47 is rotated forwardly at the rotational frequency equal to the rotational frequency at which the driving shaft 41 is rotated forwardly.

In a medium conveyor apparatus according to a comparative example 2, the first pressure roller driving shaft 51 is fixed to the first pressure roller gear 47, and the other parts are the same as those in the image reader apparatus 1. In the medium conveyor apparatus according to the comparative example 2, because the first pressure roller driving shaft 51 is fixed to the first pressure roller gear 47, the rotation of the first pressure rollers 24 is communicated to the first pressure roller gear 47. When the radius R1 is smaller than the radius R2, the rotational frequency of the rotation communicated from the first pressure rollers 24 to the first pressure roller gear 47 becomes different from the rotational frequency of the rotation communicated from the gears 43 to the first pressure roller gear 47. Because the rotational frequency of the rotation communicated from the gears 43 to the first pressure roller gear 47 is different from the rotational frequency of the rotation communicated from the first pressure rollers 24 to the first pressure roller gear 47, the driving source 35 may have an increased load thereon and experience a failure. The medium conveyor apparatus according to the embodiment described above, even when the radius R1 is smaller than the radius R2, can suppress an increase in the load imposed on the driving source 35, so as to prevent a failure, compared with the medium conveyor apparatus according to the comparative example 2.

### Advantageous Effects Achieved by Medium Conveyor Apparatus According to Embodiment

The medium conveyor apparatus according to the embodiment includes the image reader apparatus main body 2, the first feed rollers 22, the first bearings 31, the first pressure rollers 24, and the first rotation communicating mechanism 36. The first feed rollers 22 are rotatably supported by the image reader apparatus main body 2, and receive a rotating force from the driving source 35. The first bearings 31 are translationally movably supported by the image reader apparatus main body 2. The first pressure rollers 24 are rotatably supported by the first bearings 31, and press the medium against the first feed rollers 22. The first rotation communicating mechanism 36 does not communicate the rotation from the first pressure rollers 24 to the driving source 35, and communicates the rotation from the driving source 35 to the first pressure rollers 24.

At this time, when the medium moves to enter between the first feed rollers 22 and the first pressure rollers 24, the medium conveyor apparatus according to the first embodiment can communicate the rotation from the driving source 35 to the first pressure rollers 24. The medium conveyor apparatus according to the first embodiment can increase the grabbing force for allowing the medium to move to enter between the first feed rollers 22 and the first pressure rollers 24, and can allow a thick medium to move to enter between the first feed rollers 22 and the first pressure rollers 24, appropriately. Because the thick medium moves to enter between the first feed rollers 22 and the first pressure rollers 24 appropriately, the medium conveyor apparatus according to the first embodiment can convey the thick medium appropriately. Furthermore, the medium conveyor apparatus according to the first embodiment may be configured not to communicate the rotation from the first pressure rollers 24 to the driving source 35 when the first pressure rollers 24 are rotated by following the movement of the first feed rollers 22. The medium conveyor apparatus according to the first embodiment, when the rotation is not communicated from the first pressure rollers 24 to the driving source 35, can suppress an increase in the load imposed on the driving source 35, so as to prevent a failure.

Furthermore, the first rotation communicating mechanism 36 in the medium conveyor apparatus according to the embodiment includes the first joint unit 53 that communicates the rotating force from the driving source 35 to the first pressure rollers 24. At this time, with the medium conveyor apparatus according to the embodiment, even when the rotational axis of the first pressure rollers 24 is not aligned with the rotational axis of the first pressure roller driving shaft 51, the rotation can be communicated from the first pressure roller driving shaft 51 to the first pressure rollers 24, appropriately. Because the rotation is communicated from the first pressure roller driving shaft 51 to the first pressure rollers 24 appropriately, the medium conveyor apparatus according to the embodiment can allow a thick medium to move to enter between the first feed rollers 22 and the first pressure rollers 24 appropriately.

Furthermore, the medium conveyor apparatus according to the embodiment also includes the second feed rollers 23, the second pressure rollers 25, and the second rotation communicating mechanism 37. The second feed rollers 23 receives a rotating force from the driving source 35. The second pressure rollers 25 press the medium against the second feed rollers 23. The second rotation communicating mechanism 37 communicates the rotation from the driving source 35 to the second pressure rollers 25, without communicating the rotation from the second pressure rollers 25 to the driving source 35.

At this time, the medium conveyor apparatus according to the embodiment can increase the grabbing force for allowing the medium to move to enter between the second feed rollers 23 and the second pressure rollers 25, and therefore, can convey a thick medium appropriately. The medium conveyor apparatus according to the embodiment can also convey the medium so that a part of the medium between the part in contact with the first feed rollers 22 and the part in contact with the second feed rollers 23 does not slack. The medium conveyor apparatus according to the embodiment may be configured in such a manner that the second pressure rollers 25 are rotated by following the movement of the second feed rollers 23, and that the rotation is not communicated from the second pressure rollers 25 to the driving source 35. The medium conveyor apparatus according to the embodiment, when the rotation is not communicated from the second pressure rollers 25 to the driving source 35, can suppress an increase in the load imposed on the driving source 35, so as to prevent a failure.

Furthermore, the image reader apparatus 1 provided with the medium conveyor apparatus according to the embodiment includes the lower reading unit 26 and the upper reading unit 27. The lower reading unit 26 and the upper reading unit 27 capture the images of the part of the medium between the part that is in contact with the first feed rollers 22 and the part that is in contact with the second feed rollers 23. At this time, the medium conveyor apparatus according to the embodiment can convey the medium in such a manner that the part of the medium the images of which are to be captured by the lower reading unit 26 and the upper reading unit 27 does not slack, and can capture the images on the medium appropriately.

Incidentally, the medium conveyor apparatus according to the embodiment described above is provided with the second rotation communicating mechanism 37 that communicates the rotation from the driving source 35 to the second pressure rollers 25, but the second rotation communicating mechanism 37 may be omitted therefrom. The medium conveyor apparatus, when the second rotation communicating mechanism 37 is omitted therefrom, can sometimes allow the medium to move to enter between the second feed rollers 23 and the second pressure rollers 25 by conveying the medium with the first feed rollers 22 and the first pressure rollers 24.

Although the medium conveyor apparatus according to the embodiment described above is used in the image reader apparatus, the medium conveyor apparatus may also be used in another apparatus. An example of such an apparatus includes a printer. For example, when the medium conveyor apparatus is used in a printer, the reading unit is replaced with a printing unit that prints a shape onto a medium. Even when the medium conveyor apparatus is used in an apparatus that is different from the image reader apparatus, the medium conveyor apparatus can allow the medium to move to enter between the first feed rollers 22 and the first pressure rollers 24 appropriately, and reduce the load imposed on the driving source 35.

The medium conveyor apparatus disclosed herein can allow a medium to move to enter between rollers in a roller pair appropriately, and reduce the load imposed on the driving source of the roller pair.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the disclosure have been described in detail, it should be understood that the various changes, substitutions, and alterations could be made hereto without departing from the spirit and scope of the disclosure.

What is claimed is:

1. A medium conveyor apparatus comprising:
a main body;
a first roller that is rotatably supported by the main body, and that receives a rotating force from a driving source;
a bearing that is translationally movably supported by the main body;
a second roller that is rotatably supported by the bearing, and that presses a medium against the first roller; and
a rotation communicator that communicates a rotation from the driving source to the second roller, without communicating a rotation from the second roller to the driving source.

2. The medium conveyor apparatus according to claim 1, wherein the rotation communicator includes a joint that communicates a rotation from the driving source to the second roller.

3. The medium conveyor apparatus according to claim 1, further comprising:
a third roller that receives a rotating force from the driving source;
a fourth roller that presses the medium against the third roller; and
another rotation communicator that communicates a rotation from the driving source to the fourth roller, without communicating a rotation from the fourth roller to the driving source.

4. The medium conveyor apparatus according to claim 3, further comprising a reader that captures an image of a part of the medium between a part that is in contact with the first roller and another part that is in contact with the third roller.
